(19) United States
(12) Patent Application Publication
(10) Pub. No.: US 2003/0187747 A1
(43) Pub. Date: Oct. 2, 2003

(54) Order shop system

(75) Inventors: Hideki Fukasawa, Tokyo (JP); Takaaki Matsushima, Tokyo (JP); Atsutada Nakatsuji, Tokyo (JP)

Correspondence Address: SCULLY SCOTT MURPHY & PRESSER, PC, 400 GARDEN CITY PLAZA, GARDEN CITY, NY, 11530

(73) Assignee: NEC Engineering, Ltd., Tokyo (JP)

(21) Appl. No.: 10/112,528

(22) Filed: Mar. 29, 2002

(51) Int. Cl. G06F 17/60

(52) U.S. Cl. 705/26

(57) ABSTRACT

In an order shop system, a shopping mall is constituted of a body capture booth located at a center and a group of shops of different kinds located around the body capture booth. The body capture booth and the group of shops are connected by an Internet having a data center functioning as a server. The body capture booth is configured to measure the shape data of a body of an entering customer and to transmit the shape data of the body of the customer thus measured to the data center. Each of the shops of different kinds is configured to receive an order of a goods or services from the customer whose body shape data was measured in the body capture booth, and to obtain the body shape data of the customer from the data center and to actually supply the ordered goods or services prepared on the basis of the body shape data of the customer.

### BACKGROUND OF THE INVENTION

The present invention relates to an order shop system using Internet, which supplies custom-made goods or services which coincides with the physical feature of a customer (ordering person).

The thing worn by a human being, such as such as a hat, clothes, eyeglasses, a pair of shoes, a finger ring, etc., is required to have a size and a shape which are peculiar to the human being who wears the thing concerned. Therefore, the thing concerned cannot originally exert its functioning as the thing worn by the human being, if the size and the shape of the thing concerned does not balance with the size of the body of the human being who wears the thing concerned.

For example, considering the clothing, if the size and the shape of the clothing do not coincide with those of the human being who wears the clothing, it is the fact that the clothing does not function as a clothing. In fact, however, the custom-made goods are very much limited to a part of high-quality articles. In the field of clothing, most clothing are ready-made goods in which the clothing of the same kind are produced in a limited number of different sizes, and displayed and sold in a store.

It has become the common sense that, a customer, who intends to purchase goods, chooses from a large number of goods displayed in a store, one which is considered by the customer to fit with the customer (the size and the shape of the body of customer), and then, slightly modifies the size and the shape of the chosen goods to more fit with the body of the customer, with the result that the customer is satisfied by purchase of the goods fitting with the body of the customer. Preferably, the goods which a customer wishes to wear should be the goods which was made in accordance with the body of the customer, but it is merely a convenient method to choose the goods most fitting with the body of the customer, from a large number of goods.

On the other hand, at the time of ordering a clothing, a customer must actually attend the store handling the clothing concerned, so that the size of various parts of the body of the customer required to make the clothing concerned is actually measured. In order to tailor one suit, it is not sufficient if only the height, the chest girth, the girth and the length of the arm are measured.

The body shape of a human being is different from one to another, and it is a matter of technical ability to complete a suit fitting the body shape peculiar to each individual. Namely, it is not a matter that a suit can be completed if the order of the customer is simply accepted at a place like a branch office, and the dimensions of various parts of the body of the customer are measured and then is transferred to a manufacturer of the suit. As an actual matter, even if a customer wishes to make a suit in a famous tailor, if the famous tailor is not located in the neighborhood, the customer must abandon the order of the suit.

Therefore, customers residing at remote locations can have only a small opportunity of utilizing a famous specialized store in the metropolitan. This is not only a problem in the field of clothing, but also a problem common to the case in which a customer orders a goods worn on a body of a human being, such as a hat, eyeglasses, a pair of shoes, etc. Furthermore, it is the problem which will also occur in services such as barber, hairdressing and beauty treatment in which the services will be carried out in a condition directly contacting with a customer, to meet the shape of a face and the shape and position of eyes and a nose, and in a cosmetic sale in which goods was sold in a condition of actually meeting with the customer.

In order to overcome the above mentioned problem, for example, JP-A-2000-123058 (Prior art 1) proposes a clothing manufacturing data processing system of measuring a surface shape of a human body and utilizing a shape data representing the surface shape in a the three-dimensional coordinate.

JP-A-05-172524 (Prior art 2) proposes a system of measuring a face of a customer by a three-dimensional face shape measuring device to obtain a three-dimensional face shape pattern, and of manufacturing a eyeglasses frame by using the obtained three-dimensional face shape pattern.

JP-A-11-128248 (Prior art 3) proposes a system and a method of manufacturing an artificial tooth or teeth by utilizing a three-dimensional shape data of teeth of a patient.

When it is made to develop such systems actually, it is possible to finally measure the dimension of each body part, and it is not impossible to complete a suit completely fitting the body of the customer in such a manner that the order of the customer is accepted at a place like a branch office, and the dimensions of various body parts of the customer are measured and then is transferred to a manufacturer of the suit.

All the systems disclosed in the Prior arts 1 to 3, are so configured to measure the three-dimensional shape of various body parts of a human being, and to manufacture the clothing, the eyeglasses frame, and the artificial tooth or teeth with reference to the data obtained by the three-dimensional measurement. Each of these prior arts proposes to an attempt of using an apparatus for obtaining a three-dimensional image.

An example of the apparatus for obtaining the three-dimensional image is disclosed by the Prior art 1. As shown in FIG. 10, the apparatus disclosed by the Prior art 1 for obtaining the three-dimensional image comprises a three-dimensional measuring unit 25 including a vertically movable distance measuring ring 22 which comprises a plurality of distance detecting heads 21 located to form a circular ring and which can be displaced vertically along a guide 23 by a drive mechanism 24. In order to measure a surface shape of a human body 26, the human body is placed within the distance measuring ring 22, the distance measuring ring 22 is vertically displaced while operating the detecting heads 21, so that distance data obtained from the detecting heads 21 at various vertical positions of the distance measuring ring 22 is collected and processed.

In the Prior art 2, as shown in FIG. 11, the three-dimensional face shape of front and sides of a face of a person 31 to be tested is measured by projecting a laser slit light from each laser slit light source 32 through a galvano mirror 33 to the person 31 to be tested, photographing a distortion of the laser slit lights caused by concavo-convex of the face by a CCD camera 34, and then, processing the obtained image by an image encoder 35 and a computer 36 in an image synthesizing system.

In the three-dimensional shape data obtaining means used in the Prior art 3, teeth of a patient, which is an object to be photographed, is scanned while projecting a laser light, and a reflected light is detected by a CCD camera, so that a distance to the teeth is measured on the basis of the principle of the triangulation and the three-dimensional data of the teeth is supplied to a work station.

The above mentioned Prior arts 1 to 3 shows a means for obtaining the three-dimensional shape data in order to manufacture the clothing, the eyeglasses or the artificial tooth or teeth. However, all of the means are not specific. In addition, the means for obtaining the three-dimensional shape data, which is used in the respective systems, is a dedicated machines. In other words, even if the surface shape data of the human body, the three-dimensional face shape data of the front and sides of the face, and the three-dimensional face shape data of the teeth, which are obtained by those means for obtaining the three-dimensional shape data, respectively, the obtained data is inherent to the manufacturing of the clothing, the eyeglasses and the artificial tooth or teeth, but cannot be used in common to respective makers of the clothing, the eyeglasses and the artificial tooth or teeth.

### BRIEF SUMMARY OF THE INVENTION

Accordingly, it is an object of the present invention to provide an order shop system which has overcome the above mentioned problems of the prior art.

Another object of the present invention is to provide an order shop system in which a shape data of a body of a customer (a person ordering a goods or services) can be utilized in common by maker or traders of the same or different kinds of business, who can supply the goods or services requested by the customer,

The above and other objects of the present invention are achieved in accordance with the present invention by an order shop system in which data of a body shape obtained by measuring a whole body or a part of the body of customers is managed in a data base at a data center, and when an order requesting a goods or services is dispatched from a customer, a person who supplies the goods or services requested by the customer, obtains the data of the body shape of the customer from the data base, and supplies the goods or services which is requested by the customer and which is made on the basis of the data of the body shape thus obtained.

In one embodiment, the data of the body shape of the customers managed in the data base at the data center is available to not only a person receiving the order of goods or services dispatched from the customer, its related agent, an operation executing person, a medical personnel, a maker, a manufacturer and/or a seller, but also to the customer who dispatched the order of goods or services.

In another embodiment, the data of the body shape of the customers managed in the data base at the data center can be used for supplying goods or services of two or more different kinds.

In still another embodiment, the data of the body shape recorded with the progress of time can constitute data which shows the change of the symptom, the degree of the progress of the symptom, or the change of the therapy.

In a further embodiment, a figure in a past of the body and a figure after the change can be displayed and compared on a display screen so that the situation of the change of the body is visually presented before the customer, together with a numerical data.

In another embodiment, the data of the body shape obtained by measuring the whole body or the part of the body of the customers is a three-dimension image data, and the data for the goods ordered by the customer is obtained from an image data of a goods obtained by synthesizing the three-dimension image data of the body of the customer.

In another embodiment, the data of the body shape obtained by measuring the whole body or the part of the body of the customers is a three-dimension image data, and the data of the services ordered by the customer is obtained from an image data of the body of the customer modified obtained by image-processing the three-dimension image data of the body of the customer.

In another embodiment, a stereoscopic image of an actual body in accordance with the shape data of the body of the customer, and the shape data of a post-modification body obtained by image-processing the three-dimension image data of the body of the customer, are used for comparing the original body shape and the post-modification body of the customer obtained as the result of a services such as a cosmetic surgery and a beauty treatment.

In another embodiment, the data center is a server in a computer system, for managing as the data base the shape data of the body of the customers and for supplying the shape data of the body of the customer in response to a request from a person related to the goods or services ordered by the customer.

According to another aspect of the present invention, there is provided an order shop system which comprises a shopping mall including a body capture booth located at a center and a group of shops of different kinds located around the body capture booth, the body capture booth and the group of shops being connected by an Internet having a data center functioning as a server,

wherein the body capture booth is configured to measure the shape data of a body of an entering customer and to transmit the shape data of the body of the customer thus measured to the data center, and

wherein each of the shops of different kinds is configured to supply a goods or services to the customer whose body shape data was measured in the body capture booth, each shop being able to obtain the body shape data of the customer from the data center in accordance with an order from the customer and to actually supply the ordered goods or services prepared on the basis of the body shape data of the customer.

In an embodiment, the body capture booth and the group of shops are connected by the Internet having the data center functioning as the server, so as to constitute a shopping mall based on a order shopping.

In another embodiment, the body capture booth is located in a predetermined shop within the group of shops

In still another embodiment, the customer can make not only an order of a goods in a shop within the group of shops, but also an order of a goods directly to a maker by using a terminal of the customer or a terminal in the body capture booth.

The above and other objects, features and advantages of the present invention will be apparent from the following description of preferred embodiments of the invention with reference to the accompanying drawings.

### BRIEF DESCRIPTION OF THE DRAWINGS

FIG. 1 illustrates a condition of an object viewed by a camera in a three-dimensional shape measuring apparatus used in the order shop system in accordance with the present invention;

FIG. 2 illustrates a manner of measuring in a depth direction;

FIG. 3 illustrates a manner of obtaining an angle of a point on the object viewed from a light source;

FIGS. 5A, 5B and 5C illustrate stereoscopic images obtained by using the three-dimensional shape measuring apparatus used in the order shop system in accordance with the present invention;

FIG. 6 illustrates examples of goods and/or services considered in the order shop system in accordance with the present invention;

FIG. 7 illustrates an example of a shopping mall including various shops handling different goods and/or services, as tenants;

FIG. 8 illustrates a flow from an order of a goods until a manufacturing of the ordered goods in the order shop system in accordance with the present invention;

FIG. 9 illustrates a flow from registration of the body shape data to a download of the body shape data;

FIG. 10A is a vertical sectional view of the three-dimensional shape measuring apparatus in the Prior art 1;

FIG. 10B is a horizontal sectional view of the three-dimensional shape measuring apparatus in the Prior art 1; and

FIG. 11 is a block diagram illustrating the three-dimensional shape measuring apparatus in the Prior art 2.

### DETAILED DESCRIPTION OF THE INVENTION

Now, embodiments of the present invention will be described with reference to the drawings. The present invention provides an order shop system in which data of a body shape obtained by measuring a whole body or a part of the body of customers is managed in a data base at a data center, and when an order requesting a goods or services is dispatched from a customer, a person who supplies the goods or services requested by the customer, obtains the data of the body shape of the customer from the data base, and supplies the goods or services which is requested by the customer and which is made on the basis of the data of the body shape thus obtained.

The data of the body shape of the customers managed in the data base at the data center can be downloaded by not only a person receiving the order of goods or services dispatched from the customer, its related agent, an operation executing person, a medical personnel, a medical related person, a maker, a manufacturer and/or a seller, but also by the customer who dispatched the order of goods or services.

In the present invention, the “goods” should be considered to include a goods which needs data of a shape of at least one portion of the body of a customer, for example, a clothing (such an apparel, lingerie, etc.), a hairpiece, a eyeglasses, shoes, etc. These “goods” are an custom-made goods, but are not necessarily limited to the goods worn on a body or a portion of a body of a human being. The custom-made goods include a goods such as a chair, a desk and a bed, which also needs data of a shape of at least one portion of the body of a customer.

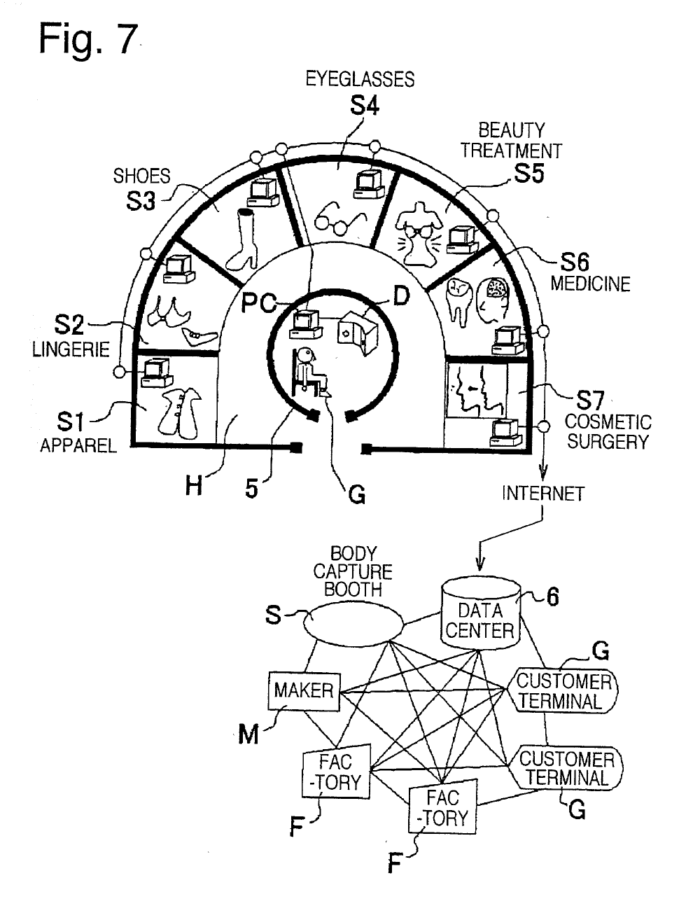

In the present invention, the “services” should be considered to include a services which needs data of a shape of at least one portion of the body of a customer, and which can be exemplified by a beauty treatment, a cosmetic surgery, a medical operation FIG. 7 illustrates a shopping mall constituted by shops as tenants, which handle the goods and the services. In the present invention, the “shopping mall” should be considered to means a shop street, an underground shop street and a shop area formed in a building.

In the present invention, the “shop” should be considered to mean facility which offer exhibition and sale of goods and services. A clinic where a medical action is carried out, is not a shop in an ordinary sense, but in the present invention, the clinic, and a facility where a cosmetic surgery is carried out, a beauty saloon are included the concept of the shop.

In order to measure the whole body or a part of the body of a customer who requests the supply of the goods or the services, the three-dimensional shape measuring apparatus is used.

The three-dimensional shape measuring apparatus used in the present invention is not used for measuring the shape of the human body required only in order to manufacture only a specific limited goods, but is used to measure the shape per se of the human body so as to output an image together with the body shape data. The three-dimensional shape measuring apparatus capable of satisfying this purpose is exemplified by a range finder available from the NEC Engineering, Ltd. under the tradename “Danae”.

Here, a multieye sine wave grating phase shift method (simply called “this method” hereinafter) which a core technology in the range finder, will be explained in the following:

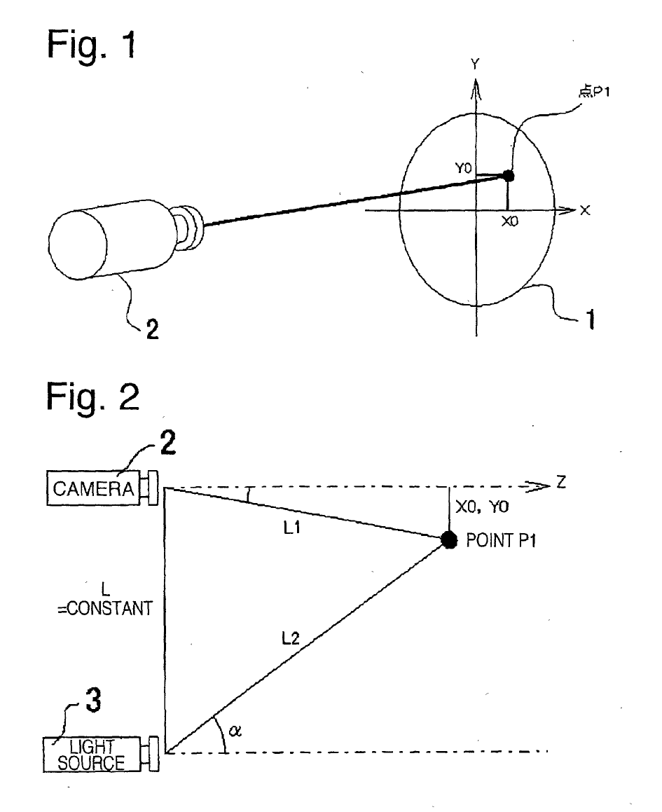

In FIG. 1, if an object 1 is viewed by a CCD camera 2, a two-dimensional information having an X coordinates (vertical) and a Y coordinates (horizontal) is obtained as an image. For example, this two-dimensional information is detected with a resolution of 640 dots in the X axis and 480 dots in the Y axis.

Assuming that the center in a visual field of the CCD camera 2 is positioned on an origin of the XY coordinate, the coordinates of a point P1 is expressed by X=X0 and Y=Y0 as shown in FIG. 1. The point P1 exists on a (X0)th dot counted rightward from the origin of the XY coordinate and on a (Y0)th dot counted upward from the origin of the XY coordinate. Thus, the distance can be known in units of dot, but, cannot known in units of millimeter.

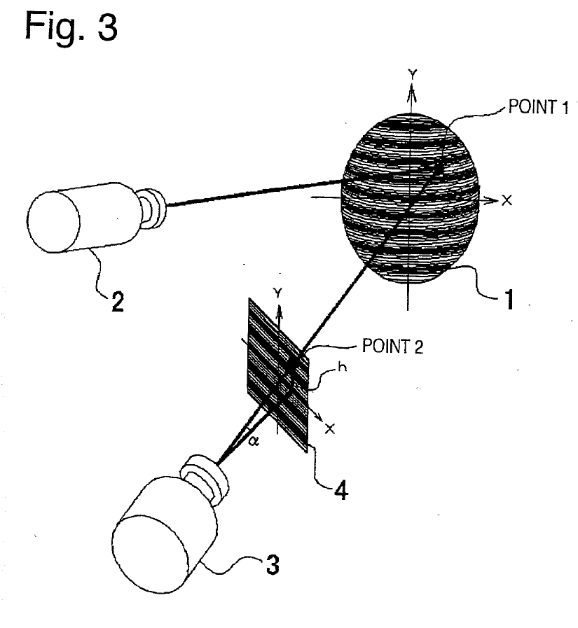

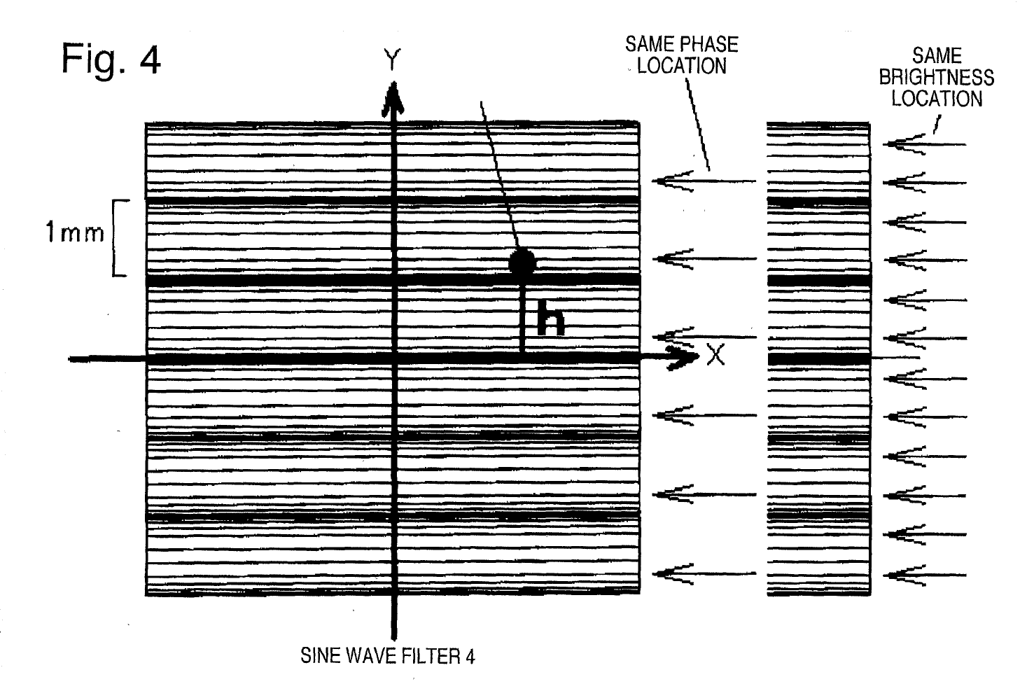

Therefore, in this method, a distance in a depth direction (the distance between the camera 2 and th point P1) is measured, and then, the XY direction distance is converted into units of millimeter. A unit for measuring the distance in a depth direction (Z direction), a light source. In FIG. 2, a camera 2 and a light source 3 are located to be directed in the same direction, at respective fixed positions which are separated from each other by a distance L. Under this condition, if an angle α (alpha) of the point P1 viewed from the light source 3, a distance L1 can be obtained in a geometrical manner. A method utilizing this angle α (alpha) is so called “sine wave light pattern”, the principle of which is illustrated in FIG. 3.

In FIG. 3, a sine wave filter 4 which can be seen to be a striped pattern is located before the light source 3. As a result, the light passing through a sine wave filter 4 is projected onto the object 1, and therefore, a regular striped pattern of strong lights and weak lights is formed on the surface of the object 1. Therefore, if the brightness on the point P1 viewed by the camera 2 is measured, it is possible to determine through which location of the sine wave filter 4 the light is projected onto the point P1. In this manner, the height of a passing point P2 in the sine wave filter 4 is calculated, and the angle α (alpha) is obtained from the distance between the camera 2 and the sine wave filter 4.

However, as shown in a right half of FIG. 4, since two locations having the same brightness exist in the range of each one period in the sine wave, it is not possible to determine through which location of the sine wave filter 4 the light is projected onto the point P1. Therefore, by vertically shifting the sine wave filter 4, the shift of the bright stripes can be ascertained to seek the phase φ (phi).

Thus, as shown in a left half of FIG. 4, the location of the same phase can be specified, so that the height “h” of the passing point P2 in the sine wave filter 4 is expressed by the following equation (1):

h=2πn×φ(mm) (1)

where

h is the distance from the center in the Y direction

φ is a phase calculated from the brightness of the point P1

n is the number of the phase concerned and a factor which cannot be ascertained in the explanation mentioned above.

However, in the prior art, “h” could be calculated in a convenient manner. The reason for this is that the phase measurement used in the prior art utilizes only one period of sine wave. This is an advantage of this method. Namely, this method for projecting the sine wave light having a plurality of periods of sine wave can increase the precision of the measurement by increasing the number of steps of the brightness change.

The “multieye” in the multieye sine wave grating phase shift method means use of a plurality of pairs, each pair composed of one camera and one light source, for measurement. This is the purpose of ascertaining the phase “n”, namely, of determining an absolute phase. The calculation for determining the absolute phase is very complicated, and explanation will be omitted since it is out of the spirit of the present invention and since it is described in JP-A-2000-161404.

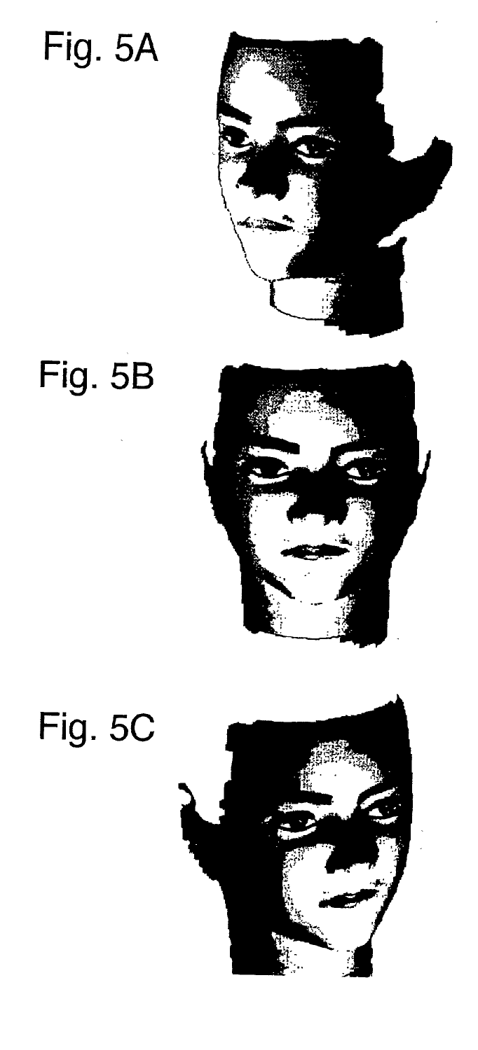

The range finder available from the NEC Engineering, Ltd. under the tradename “Danae” can optically detect an image and also can measure in a three-dimensional manner a distance of all points (not greater than 1 mm in pitch) in the visual field on the object, by utilizing sides and angles of a triangle formed by the camera (all points detected by all CCD sensor elements), the light source and the point on the object. For example, as shown in FIGS. 5A, 5B and 5C, a stereoscopic image which can be viewed from an arbitrary viewpoint, can be formed in a virtual space, and therefore, it is possible to free obtain a shape data from the stereoscopic image, and in addition, it is possible to detect and store a stereoscopic image of the whole body with the same degree of precision.

In addition, by modifying this shape data in various manners, it is possible to reproduce an image in a desired scale and shape. With appearance of this type three-dimensional shape measuring apparatus, it firstly becomes possible to realize the order shop system in accordance with the present invention in which the shape data of a customer obtained by using the three-dimensional shape measuring apparatus is used in common by two or more traders of the same kind and/or different kinds in order to supply the goods and/or services requested by the customer. In addition, it becomes possible to realize a shopping mall including shops supplies custom-made goods and various kinds of services.

However, although the body shape data obtained by the range finder available from the NEC Engineering, Ltd. under the tradename “Danae” is in common to various traders, the data for the eyeglasses and the data for the artificial tooth are not necessarily used in common. Here, the data in common to various traders should be understood to mean that the data used for supplying different kinds of goods or services, such as the data for the eyeglasses and the data for the artificial tooth, can be obtained by the same three-dimensional shape measuring apparatus.

By using the range finder available from the NEC Engineering, Ltd. under the tradename “Danae”, the data for the eyeglasses can be obtained from a face shape data. If a face shape data is obtained when a mouth is greatly opened, the data for the artificial tooth can be obtained. The face shape data obtained when a mouth was greatly opened constitutes a body shape data of the customer concerned, with a face shape data obtained when a mouth was closed. Therefore, if the body shape data of the customer concerned is inputted, it can be utilized not only as the data for the eyeglasses but also as the data for the artificial tooth.

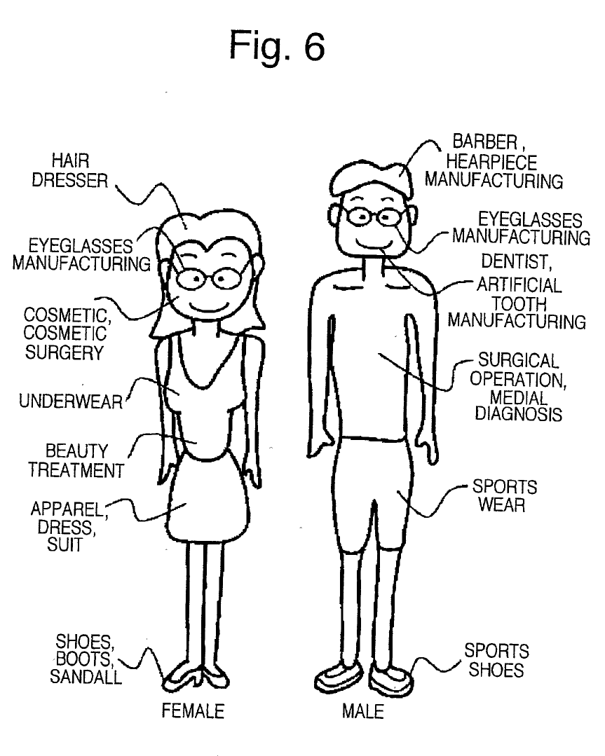

The goods and/or the services considered in the order shop system in accordance with the present invention is not necessarily limited. In a female shown in FIG. 6, the goods and/or the services include a hair dresser, a eyeglasses manufacturing, a cosmetic, a cosmetic surgery, an underwear, a beauty treatment, an apparel, a dress, a suit, shoes, boots, a sandal in the order from a head to a foot. Fundamentally, a male is similar to the female. In the example shown in FIG. 6, a hair medicine, a hairpiece manufacturing, dentist, artificial tooth manufacturing, a surgical operation, a medical diagnosis, sportswear, pair of sports shoes are exemplified.

In the order shop system in accordance with the present invention, first, a customer comes a place where the three-dimensional shape measuring apparatus is located, and a three-dimensional shape data of at least a body portion of the customer required for the goods or the services which the customer wish to order, is picked up.

From the picked-up three-dimensional shape data of the body portion of the customer himself or herself, an image of the body shape of the customer himself or herself is displaced in a display screen of a computer located at the same place, and the customer can virtually confirm an image of the customer having worn the goods which the customer wish to order. If the customer is pleased with the goods, the customer can actually make an order.

If the services is a beauty care services, the customer can virtually confirm the change of the shape after the services has been carried our for the customer. If it is acceptable, the customer can actually make an order.

If the place where the three-dimensional shape measuring apparatus is located is a shop for supplying the goods or the services for which the customer wishes to obtain, it is sufficient if the customer actually makes an order to the shop concerned. In this case, it is in some cases that the customer can acquire the good in the shop concerned or alternatively can receive the services from the shop concerned.

In the present invention, the three-dimensional body shape data is transmitted to a data center and managed at the data center to be able to supply the data to traders of different kinds so that the data is utilized in common by the traders of different kinds. The data is utilized as follows:

Namely, the data center retains the received three-dimensional body shape data. A first shop which has received an order from a customer, sends an order of a first goods to a first maker. The first maker which has received the order from the first shop, transmits, in accordance with the received order information, the management number of the three-dimensional body shape data, the order information and the communication destination information to a first factory. The first factory acquires the three-dimensional body shape data of the customer from the data center, and actually manufactures the ordered first goods, and then, delivers the completed first goods directly to the orderer in accordance with the communication destination information. This procedure will be carried out when a second shop has received an order which is dispatched from the same customer and which us requesting a second goods different from the first goods. Namely, the second shop sends an order of the second goods to a second maker, and the second maker transmits, in accordance with the received order information, the management number of the three-dimensional body shape data, the order information and the communication destination information to a second factory. The second factory acquires the three-dimensional body shape data of the customer from the data center, and actually manufactures the ordered second goods.

This is a simple example of the procedure until the order goods is delivered to the orderer, it would be understood that there can exist a variety of procedures until the order goods is delivered to the orderer.

In order to realize the order shop system in accordance with the present invention, it is not necessary to locate the three-dimensional shape measuring apparatus in each shop, but it is sufficient if the three-dimensional shape measuring apparatus is located in a body capture booth and if a shopping mall is constituted by placing the body capture booth at a center. A conception in which one shopping mall is constituted by placing the body capture booth at the center and can supply various kinds of goods and/or services, is a figure of a new commerce.

In FIG. 7, a building constituting a shopping mall accommodates, as a tenant shop, shops S1 to S4 handling the goods such as apparel, lingerie, shoes and eyeglasses, and specialized services shops S5 and S6 and a clinic S7 for supplying a beauty treatment, a medicine and a cosmetic surgery. At a hall, there is placed a body capture booth 5 in which a three-dimensional shape measuring apparatus D is located.

In the body capture booth 5, the body shape of an entering customer is measured by the three-dimensional shape measuring apparatus D, and the body shape data obtained of the customer is transmitted to the data center 6 through an Internet. To the data center, other groups of shops Sn, makers M, factories F and customer's terminals G are connected through the Internet.

In this embodiment, a customer which wishes to make an order of a goods or a services fitted with the body of the customer himself or herself, goes to the shopping mall, and stands or sits down on a chair, to face the three-dimensional shape measuring apparatus D within the body capture booth 5 at the hall H, so that the whole body or a part of the body of the customer himself or herself is measured. The measurement is actually a photographing, which entails about three seconds.

The shape data of the customer thus measured is a three-dimensional image data, which is transmitted through the Internet to the data center 6 functioning as a server and then managed in a data base of the data center 6 in a concentrated manner. The customer G can ascertain the body shape data of the customer himself or herself thus measured, in the form of an image on a personal computer PC which is a terminal within the booth. Here, the image photographed must include a portion related to the goods or the services which the customer wishes to order.

After photographing, the customer G comes out of the body capture booth 5, and actually goes to a shop handling the goods which the customer wishes to acquire, or the specialized shop or clinic supplying the services which the customer wishes to acquire. Then, the customer actually makes an order to a seller in the shop, or requests a supply of the services to an instructor or a medical care to a doctor in the clinic.

For making it easier to understand, an example of ordering eyeglasses fitted with the customer, in a eyeglasses shop, will be explained.

A seller who has received the order from the customer, connects a personal computer PC within the shop to the Internet to access the data center 6, and downloads the body shape data of the customer who is the orderer, and displays a stereoscopic image of the face of the customer on a display screen of the personal computer PC. In addition, the seller synthesizes an image data of the eyeglasses, applies the image of the eyeglasses to the stereoscopic image of the face of the customer, and adjusts an eyeglasses frame and the shape and the length of the temple in the image of the eyeglasses.

When the shape of the eyeglasses coincides with the desire of the orderer, the shape data of the image of the eyeglasses directly becomes the shape and the size of the goods without modification. Of course, it is possible to extract only necessary data from the downloaded body shape data of the customer, and to determine the shape and the size of the eyeglasses from the extracted data.

On the other hand, the attempt of utilizing the shape data of the image for the shape and the size of the goods can be applied without modification to the clothing such as the apparel and the lingerie and the shoes. Namely, it is possible to obtain the shape data directly from the three-dimensional image data of the body of the customer displayed on the display screen of the personal computer PC. However, the shape data of the image of the apparel, the lingerie and the shoes worn on the body of the customer displayed on the display screen of the personal computer PC, becomes directly the shape and the size of the goods.

On the other hand, the services such as the medical care, the cosmetic surgery and the beauty treatment does not handle the goods. However, it is possible to perform a surgical diagnosis from the stereoscopic image of the body displayed on the display screen of the personal computer PC on the basis of the shape data downloaded from the data center 6, and the data of the body shape recorded with the progress of time shows the change of the symptom, the degree of the progress of the symptom, or the situation of the therapy.

In the operation of the services such as the cosmetic surgery and the beauty treatment, by comparing the stereoscopic image of the actual body displayed on the display screen of the personal computer PC with a figure after change which is also displayed on the display screen by processing the stereoscopic image of the actual body to obtain a virtual stereoscopic image of the nose shape or the body shape improved by the cosmetic surgery or the beauty treatment, it is possible to obtain a material for recommending the cosmetic surgery or the beauty treatment, and to give the customer a specific guideline as to which portion of the body should be improved and to what degree the body should be improved. In addition, an expected result of the cosmetic surgery or the beauty treatment can be visually shown with the numerical data by finely comparing the body images before and after the cosmetic surgery or the beauty treatment, including a small part of the body.

The above mentioned embodiment is a simple example, but-the present invention is not limited to the supply of the goods and/or services. In addition, utilization of the three-dimensional body shape date and the image data obtained by the three-dimensional shape measuring apparatus is not limited to the above mentioned examples.

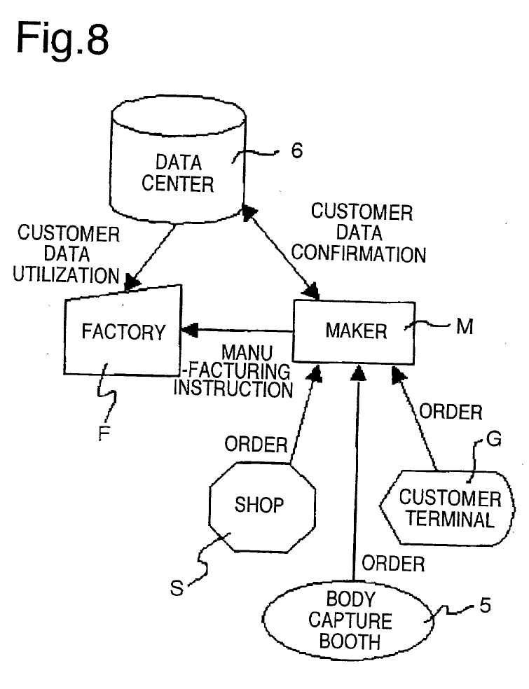

Furthermore, in the order shop system in accordance with the present invention, the customer can makes an order not only the shop but also but also an order of a goods directly to a maker M by using a terminal of the customer G or a terminal in the body capture booth 5, depending upon the kind of the goods, as shown in FIG. 8. The maker M who has received the order from the customer G, accesses the data center 6 to confirm that the body shape data of the customer G exists in the data center, and then, sends the instruction to a factory F. The factory F downloads the data necessary to manufacture the ordered goods, from the data center 6, and actually manufactures the ordered goods on the basis of the downloaded data.

In many case, the services such as the medical care, the cosmetic surgery and the beauty treatment can be obtained in the corresponding shops. However, when the clinic requests an instruction from a college's hospital, or when the ordered services needs a manufacturing of a goods, a respective entity can utilize the data stored in the data center 6 as shown in FIG. 8,

In the example, because of the convenience of the description of the system of the present invention, the body capture booth is located at the center of the hall of the shopping mall, in order to describe that the body capture booth is functionally independent of the business of each shop, but can be located in a selected shop if an administrator is previously designated

In the above description, the shop is a shop actually selling the goods or actually supplying the services. However, the shop is a branch office where a person always resides who can explain the goods or the services to customers. The shops and the body capture booth are not necessarily required to exist within the same shopping mall. However, since a customer enters the body capture booth in order to acquire the goods or the supply of the services, it is a matter of course that shops for supplying the goods and/or services are preferably located near to the body capture booth.

As seen from the above, the shopping mall constituted by the system in accordance with the present invention, includes shops of different kinds located around the body capture booth, the body capture booth and the shops of different kinds being connected by the Internet having a data center as a server, and each of the shops of different kinds being a specialized shop for a custom-made goods or services (order shop)

The shopping mall constituted of specialized order shops has not yet existed, and therefore, can be expected as a new type shopping street or area.

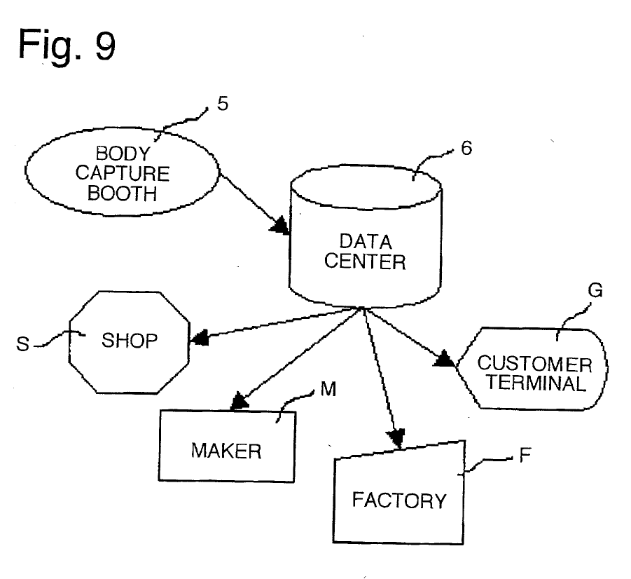

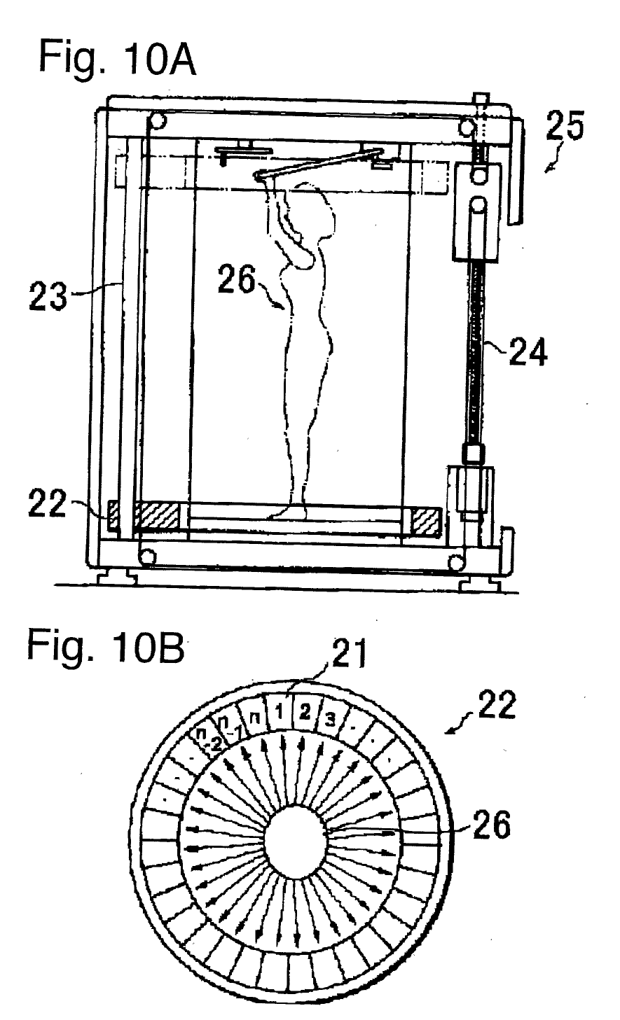

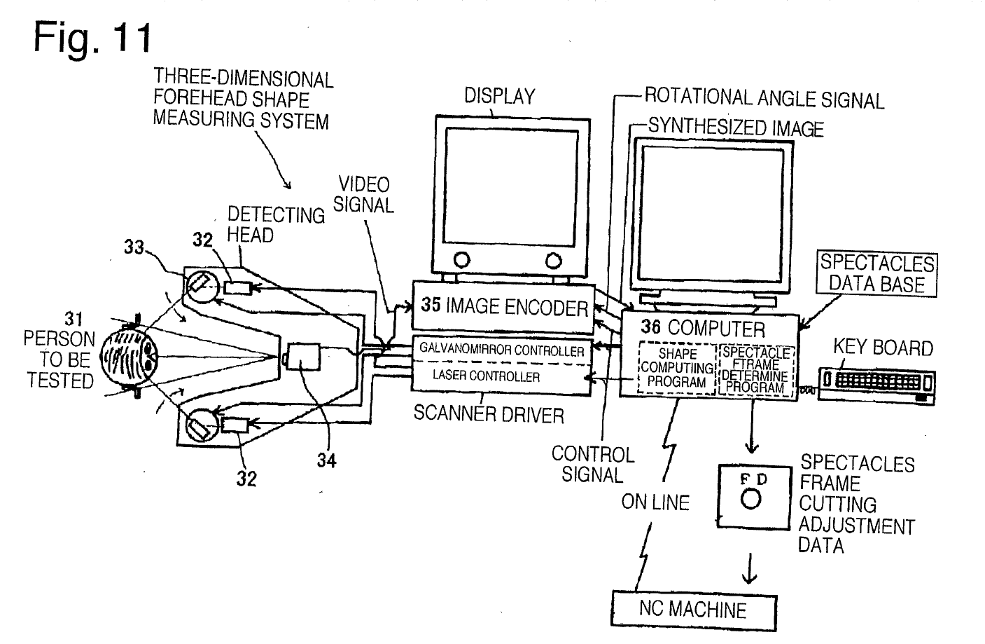

In the present invention, whether or not a shop functions as a maker or factory is not a problem. The present invention is characterized in that, as shown in FIG. 9, the body shape data of customers measured in the body capture booth 5 is a three-dimensional image data, and retained as the data base in the data center 6, and the body shape data retained in the data center 6 can be accessed and downloaded from the data center 6 through the Internet by a terminal of the shop S, the maker M and the factory F which handles the goods or services of the same kind or different kinds, and a terminal of the customer G, so that each of the shop S, the maker M, the factory F and the customer G can utilize the downloaded data for respective purpose.

As seen from the above, the present invention makes it possible to supply a custom-made goods and/or services, which was not considered in the prior art as utilization of the three-dimensional shape measuring apparatus which was developed and reduced into practice under the range finder available from the NEC Engineering, Ltd. under the tradename “Danae”.

According to the present invention, since the body shape data of customers measured by the three-dimensional shape measuring apparatus is managed at the data center in a concentrated manner, a person who supplies the goods or services in response to an order from a customer, can acquire the body shape data of the customer concerned from the data base, and can actually supply the goods or services prepared on the basis of the acquired body shape data. In addition, the body shape data of customers can be utilized in common for supplying the goods or services of different kinds.

The data of the body shape of the customers managed in the data base at the data center is available to not only a person receiving the order of goods or services dispatched from the customer, its related agent, an operation executing person, a medical personnel, a maker, a manufacturer and/or a seller, but also to the customer who dispatched the order of goods or services. Therefore, even if the customer does not actually attend the shop, the customer can makes an order of a custom-made goods. Even if a customer resides at a remote location, if the body shape data of the customer concerned is registered in the data center, the customer concerned can make an order of a custom-made goods to a famous specialized store in the metropolitan or directly to a maker.

In addition, the present invention makes it possible not only to make an order of a custom-made goods from a remote location, but also to constitute a new type shopping mall in which shops of different kinds are located around the body capture booth in which the body shape data of a customer is measured and transmitted to a data center. With this proposal, a new business constituted of a group of shops of different kinds can be developed to form a core in a new town building.

The invention has thus been shown and described with reference to the specific embodiments. However, it should be noted that the present invention is in no way limited to the details of the illustrated structures but changes and modifications may be made within the scope of the appended claims.

1. An order shop system in which data of a body shape obtained by measuring a whole body or a part of the body of customers is managed in a data base at a data center, and when an order requesting a goods or services is dispatched from a customer, a person who supplies said goods or services requested by said customer, obtains the data of the body shape of said customer from said data base, and supplies said goods or services which is requested by said customer and which is made on the basis of the data of the body shape thus obtained.

2. An order shop system claimed in claim 1 wherein said data of the body shape of the customers managed in said data base at said data center is available to not only a person receiving the order of goods or services dispatched from said customer, its related agent, an operation executing person, a medical personnel, a maker, a manufacturer and/or a seller, but also to said customer who dispatched said order of goods or services.

3. An order shop system claimed in claim 1 wherein said data of the body shape of the customers managed in said data base at said data center can be used for supplying goods or services of two or more different kinds.

4. An order shop system claimed in claim 3 wherein said data of the body shape recorded with the progress of time constitutes data which shows the change of the symptom, the degree of the progress of the symptom, or the change of the therapy.

5. An order shop system claimed in claim 4 wherein a figure in a past of the body and a figure after the change are displayed and compared on a display screen so that the situation of the change of the body is visually presented before said customer, together with a numerical data.

6. An order shop system claimed in claim 1 wherein said data of the body shape obtained by measuring the whole body or the part of the body of the customers is a three-dimension image data, and the data for the goods ordered by said customer is obtained from an image data of a goods obtained by synthesizing said three-dimension image data of the body of said customer.

7. An order shop system claimed in claim 1 wherein said data of the body shape obtained by measuring the whole body or the part of the body of the customers is a three-dimension image data, and the data of the services ordered by said customer is obtained from an image data of the body of said customer modified obtained by image-processing said three-dimension image data of the body of said customer.

8. An order shop system claimed in claim 7 wherein a stereoscopic image of an actual body in accordance with the shape data of the body of the customer, and the shape data of a post-modification body obtained by image-processing said three-dimension image data of the body of said customer, are used for comparing the original body shape and the post-modification body of said customer obtained as the result of a services such as a cosmetic surgery and a beauty treatment.

9. An order shop system claimed in claim 1 wherein said data center is a server in a computer system, for managing as the data base the shape data of the body of the customers and for supplying the shape data of the body of said customer in response to a request from a person related to the goods or services ordered by said customer.

10. An order shop system which comprises a shopping mall including a body capture booth located at a center and a group of shops of different kinds located around said body capture booth, said body capture booth and said group of shops being connected by an Internet having a data center functioning as a server,
wherein said body capture booth is configured to measure the shape data of a body of an entering customer and to transmit the shape data of the body of said customer thus measured to said data center, and
wherein each of said shops of different kinds is configured to supply a goods or services to the customer whose body shape data was measured in said body capture booth, each shop being able to obtain the body shape data of said customer from said data center in accordance with an order from said customer and to actually supply the ordered goods or services prepared on the basis of the body shape data of said customer.

11. An order shop system claimed in claim 10 wherein said body capture booth and said group of shops are connected by said Internet having said data center functioning as the server, so as to constitute a shopping mall based on a order shopping.

12. An order shop system claimed in claim 10 wherein said body capture booth is located in a predetermined shop within said group of shops

13. An order shop system claimed in claim 10 wherein said customer can make not only an order of a goods in a shop within said group of shops, but also an order of a goods directly to a maker by using a terminal of said customer or a terminal in said body capture booth.
